(19) United States
(12) Patent Application Publication
(10) Pub. No.: US 2023/0160391 A1
(43) Pub. Date: May 25, 2023

(54) CEILING FAN AND METHOD FOR MANUFACTURING CEILING FAN BLADE

(71) Applicant: New Century Electrical Manufacturing (Zhongshan) Co., Ltd, Zhongshan City (CN)

(72) Inventor: Qirong Lu, Zhongshan City (HK)

(21) Appl. No.: 17/658,211

(22) Filed: Apr. 6, 2022

(30) Foreign Application Priority Data
Nov. 23, 2021 (CN) 202111390402.3

(51) Int. Cl. F04D 25/08; F04D 29/34; F04D 29/38

(52) U.S. Cl. CPC F04D 25/088; F04D 29/34; F04D 29/388; F04D 29/386; F05D 2230/90

(57) ABSTRACT

The invention disclosure provides ceiling fan, comprising shell, electric machine installed in shell, electric machine connected more than three pieces, each pieces connected blade, blade comprises inner layer, outside of it connected main layer, upper and lower ends of blade layer are provided with dampproof covering layer, covering layer is arranged on upper side of blade main layer, it is aerofoil type blade, blade main layer comprises upper shell, lower shell in clamping connection with upper shell, both shell are hollow and honeycomb structure is arranged on hollow portion of both shell, a gap is formed between connecting surfaces of both shell, sealing coating is arranged in the gap, connecting spray coating is sprayed on peripheral edges of both shell. The present disclosure overcomes the shortcomings of the prior art and provides ceiling fan simple structure and environment friendliness. The invention provides method for manufacturing ceiling fan.

### CROSS-REFERENCE TO RELATED APPLICATIONS

This is a U.S. patent application which claims the priority and benefit of Chinese Patent Application Number 202111390402.3, filed on Nov. 23, 2021, the disclosure of which is incorporated herein by reference in its entirety.

### TECHNICAL FIELD

The present disclosure relates to a ceiling fan and a method for manufacturing a ceiling fan blade.

### BACKGROUND

Most of the fan blades of the existing ceiling fans are made of composite plates. This kind of composite plate fan blades has heavy weight and uses many materials, which will cause waste during processing. Moreover, this kind of composite plate fan blades cannot be recycled and reused after being damaged, which is not environmentally friendly.

The present disclosure just occurs based on the above shortcomings.

### SUMMARY

The present disclosure aims to overcome the shortcomings of the prior art, and to provide a ceiling fan with simple structure and environment friendliness.

The present disclosure further provides a method for manufacturing a ceiling fan blade.

The present disclosure is implemented through the following technical scheme.

A ceiling fan includes a shell 1, wherein an electric machine 2 is installed in the shell 1, the electric machine 2 is connected with at least three connecting pieces 3, and each of the connecting pieces 3 is detachably connected with a ceiling fan blade 4, the ceiling fan blade 4 includes an inner core layer 41 made of a carbon-fiber material, an outside of the inner core layer 41 is connected with a blade main body layer 42 made of a molding pulp material, both upper and lower ends of the blade main body layer 42 are provided with a dampproof covering layer 43, and an antistatic covering layer 44 is further arranged on an upper side of the blade main body layer 42, the blade main body layer 42 is an aerofoil type blade, and the blade main body layer 42 includes an upper shell 421 and a lower shell 422 in clamping connection with the upper shell 421, the upper shell 421 and the lower shell 422 are both hollow structures and a honeycomb structure 401 is arranged on the hollow portion of both the upper shell 421 and the lower shell 422, a gap is formed between connecting surfaces of the upper shell 421 and the lower shell 422, a sealing coating 423 is arranged in the gap, and a connecting spray coating 45 is sprayed on peripheral edges of the upper shell 421 and the lower shell 422.

The lower shell 422 includes a lower connection plate 4221, the lower connection plate 4221 is provided with a connecting protrusion 4222 and the lower connection plate 4221 is further provided with a plurality of protruded ribs 4223, the upper shell 421 includes an upper connection plate 4211, the upper connection plate 4211 is provided with a protrusion part 4212 and the protrusion part 4212 defines a fixing clamping groove 4213 capable of being fixed onto the rib 4223 in a clamping manner, the connecting protrusion 4222 and the protrusion part 4212 form the gap when the lower shell 422 and the upper connection plate 4211 are in clamping connection.

The upper shell 421 and the lower shell 422 both include a tabulate fixing part 51, a tail edge of the fixing part 51 is connected with a blade part 52, and between the fixing part 51 and the blade part 52 is arranged a transition part 53 allowing an oblique arrangement of the blade part 52 relative to the horizontal plane.

The transition part 53 is twisted from head to tail, such that one side of the blade part 52 is protruded upwards and the other side is protruded downwards, which makes the blade part 52 inclined towards a rotating direction.

The transition part 53 causes an inclined angle α in a range of 15-30 degrees between the blade part 52 and the horizontal plane.

An upper surface of the upper shell 421 near a tail part is provided with a protrusion 4214, one side of the protrusion 4214 presents a cambered surface, and one side of the protrusion 4214 presents a vertical surface.

The connecting piece 3 is a connecting sheet, one end of the connecting sheet is fixed to the electric machine 2, and between the other end of the connecting sheet and the ceiling fan blade 4 is arranged a quick installation structure 6 capable of connecting them.

The connecting piece 3 defines a plurality of connecting holes 31, the ceiling fan blade 4 defines mounting holes 402 corresponding to the positions of the plurality of connecting holes 31, the quick installation structure 6 includes a connecting pin 61 which can penetrate through the connecting piece 3 and the ceiling fan blade 4 at the same time, and the connecting pin 61 is connected with a clamping lock element 62 which, when clamped on the connecting pin 61, can press against the connecting pin 61 and the surface of the ceiling fan blade 4 at the same time so as to fasten the ceiling fan blade 4 and the connecting piece 3.

A rubber ring 403 is installed inside the mounting hole 402, the rubber ring 403 defines in the middle a channel 4031 allowing the connecting pin 61 to pass through, both ends of the rubber ring 403 are provided with a protruded ring 4032, between the two protruded rings 4032 is defined a meshing clamping groove 4033 which can fit the upper and lower surfaces of the ceiling fan blade 4 and can be meshed with the ceiling fan blade 4, the clamping lock element 62 is a circular clamping lock sheet, the clamping lock sheet defines an opening clamping groove 621 allowing the connecting pin 61 to be clamped in, the clamping lock sheet at two ends of the opening clamping groove 621 is provided with an extension part 622 extending outwards, the extension part 622 defines a through hole 6221 allowing a quick installation tool to be inserted into, the opening of the opening clamping groove 621 can be expanded for the connecting pin 61 to be clamped in when a quick installation tool is inserted into the through hole 6221 and a force is applied, a head part of the connecting pin 61 presents an umbrella shape, the connecting pin 61 further defines a clamping lock groove 611 allowing the clamping lock element 62 to be clamped in, a diameter of the connecting pin 61 at the clamping lock groove 611 is less than other portions, and when the clamping lock sheet is clamped in the clamping lock groove 611, upper and lower ends of the clamping lock sheet press against the rubber ring 403 and the inner wall of the connecting pin 61 respectively to as to fasten the connecting piece 3 and the ceiling fan blade 4.

A method for manufacturing a ceiling fan blade includes the following steps of:

a. cutting a carbon fiber sheet along an outline of the ceiling fan blade to obtain an inner core layer 41;

b. importing a molding pulp into molds corresponding to an upper shell 421 and a lower shell 422 respectively to prepare an upper shell 421 and a lower shell 422;

c. hole-processing and groove-processing the inner core layer 41 and then brushing a glue over it and finally mounting it to the lower shell 422;

d. brushing a glue over corresponding fitting surfaces of the lower shell 422 and the upper shell 421 and then putting the upper shell 421 onto the lower shell 422;

e. sticking a dampproof covering layer 43 on outer surfaces of the upper shell 421 and the lower shell 422;

f. sticking an antistatic covering layer 44 on the outer surface of the upper shell 421;

g. spraying a connecting spray coating 45 along lateral surfaces of the upper shell 421 and the lower shell 422.

Compared with the prior art, the present disclosure has the following advantages. The ceiling fan blade of the ceiling fan provided in the present disclosure is provided with the inner core layer. Since the inner core layer is a sheet made of a carbon-fiber material, two sides of the inner core layer are provided with the upper shell and the lower shell made of a molding pulp material, both the upper shell and the lower shell are hollow structures, and a honeycomb structure is arranged on the hollow portion, the weight of the whole ceiling fan blade can be reduced. In addition, the honeycomb structure is evenly distributed; therefore, the ceiling fan blade will have a more balanced rotation, without the occurrence of up-down offset and jitter. The inner core layer is connected to the upper shell and the lower shell using a strong glue, and the upper shell is connected to the lower shell using a strong glue too, which achieves secure fixing. The dampproof covering layer is stuck on surfaces of both the upper shell and the lower shell, to resist water and moisture. In addition, the antistatic covering layer is stuck on the surface of the upper shell, which can prevent the ceiling fan blade being stained with dust; meanwhile, the connecting spray coating also employs a glue to fasten the upper shell and the lower shell. If the ceiling fan blade is damaged, since the inner core layer is made of a carbon-fiber material and has a high compression resistance, the inner core layer can still be recycled and reused; furthermore, since the blade main body layer is made of a molding pulp material, it can still be recycled and reused even if damaged, which is more environmentally friendly. The whole ceiling fan to which the ceiling fan blade is connected has a lighter weight. It is convenient for a user to hang the ceiling fan.

### BRIEF DESCRIPTION OF THE DRAWINGS

FIG. 1 is a stereogram of a ceiling fan according to the present disclosure.

FIG. 2 is a sectional view of a ceiling fan blade of a ceiling fan according to the present disclosure.

FIG. 3 is a diagram of a lower shell of a ceiling fan according to the present disclosure.

FIG. 4 is a diagram of an upper shell of a ceiling fan according to the present disclosure.

FIG. 5 is a stereogram of a ceiling fan blade of a ceiling fan according to the present disclosure.

FIG. 6 is a plan view of a ceiling fan blade of a ceiling fan according to the present disclosure.

FIG. 7 is a stereogram of a ceiling fan blade and a connecting piece of a ceiling fan according to the present disclosure that are connected.

FIG. 8 is an exploded view of a ceiling fan blade and a connecting piece of a ceiling fan according to the present disclosure.

FIG. 9 is an enlarged view of part A shown in FIG. 7.

FIG. 10 is an explode view of a quick installation structure 6 according to the present disclosure.

### DETAILED DESCRIPTION

The present disclosure is described below in further detail in combination with accompanying drawings.

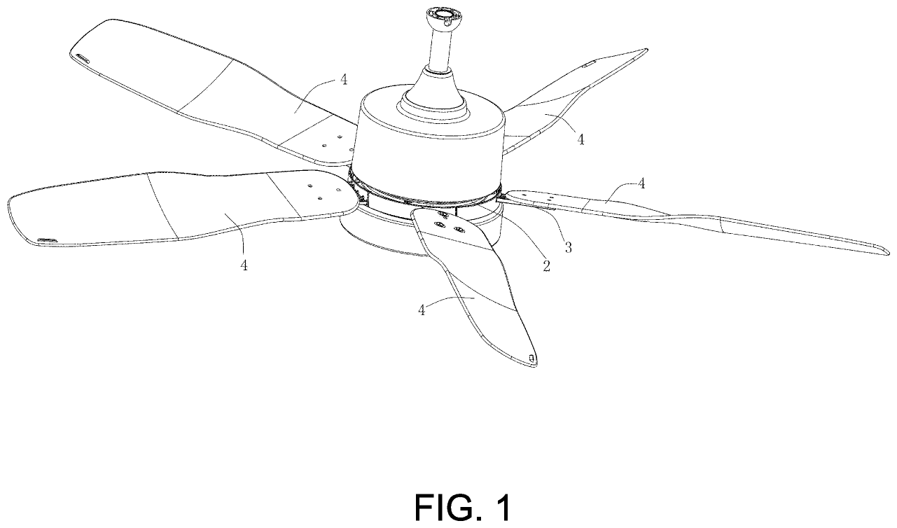

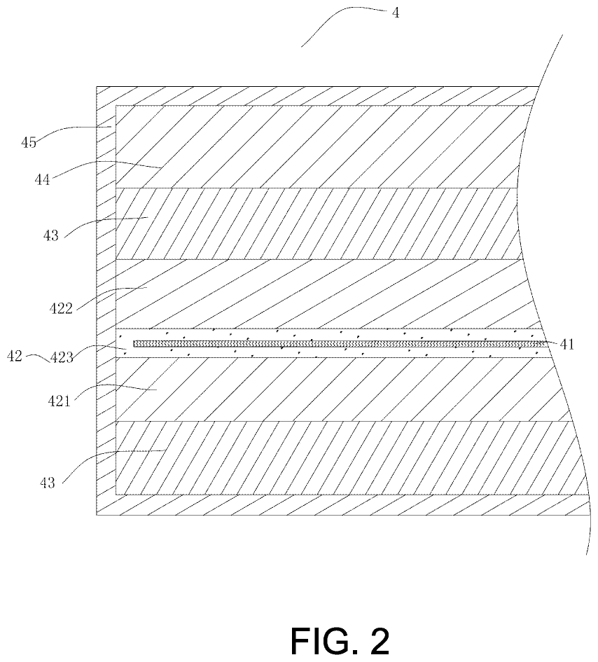

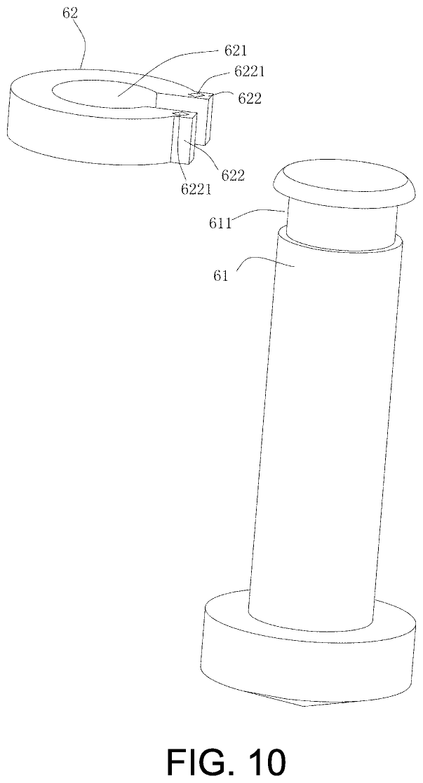

As shown in FIG. 1 to FIG. 10, the present disclosure provides a ceiling fan, including a shell 1, wherein an electric machine 2 is installed in the shell 1, the electric machine 2 is connected with at least three connecting pieces 3, and each of the connecting pieces 3 is detachably connected with a ceiling fan blade 4, the ceiling fan blade 4 includes an inner core layer 41 made of a carbon-fiber material, an outside of the inner core layer 41 is connected with a blade main body layer 42 made of a molding pulp material, both upper and lower ends of the blade main body layer 42 are provided with a dampproof covering layer 43, and an antistatic covering layer 44 is further arranged on an upper side of the blade main body layer 42, the blade main body layer 42 is an aerofoil type blade, and the blade main body layer 42 includes an upper shell 421 and a lower shell 422 in clamping connection with the upper shell 421, the upper shell 421 and the lower shell 422 are both hollow structures and a honeycomb structure 401 is arranged on the hollow portion of both the upper shell 421 and the lower shell 422, a gap is formed between connecting surfaces of the upper shell 421 and the lower shell 422, a sealing coating 423 is arranged in the gap, and a connecting spray coating 45 is sprayed on peripheral edges of the upper shell 421 and the lower shell 422.

The ceiling fan blade 4 of the ceiling fan provided in the present disclosure is provided with the inner core layer 41. Since the inner core layer 41 is a sheet made of a carbon-fiber material, two sides of the inner core layer 41 are provided with the upper shell 421 and the lower shell 422 made of a molding pulp material, both the upper shell 421 and the lower shell 422 are hollow structures, and a honeycomb structure 401 is arranged on the hollow portion, the weight of the whole ceiling fan blade 4 can be reduced. In addition, the honeycomb structure 401 is evenly distributed; therefore, the ceiling fan blade will have a more balanced rotation, without the occurrence of up-down offset and jitter. The inner core layer 41 is connected to the upper shell 421 and the lower shell 422 using a strong glue, and the upper shell 421 is connected to the lower shell 422 using a strong glue too, which achieves secure fixing. The dampproof covering layer 43 is stuck on surfaces of both the upper shell 421 and the lower shell 422, to resist water and moisture. In addition, the antistatic covering layer 44 is stuck on the surface of the upper shell 421, which can prevent the ceiling fan blade 4 being stained with dust; meanwhile, the connecting spray coating 45 also employs a glue to fasten the upper shell 421 and the lower shell 422. If the ceiling fan blade 4 is damaged, since the inner core layer 41 is made of a carbon-fiber material and has a high compression resistance, the inner core layer 41 can still be recycled and reused; furthermore, since the blade main body layer 42 is made of a molding pulp material, it can still be recycled and reused even if damaged, which is more environmentally friendly. The whole ceiling fan to which the ceiling fan blade 4 is connected has a lighter weight. It is convenient for a user to hang the ceiling fan. The antistatic covering layer is a paster coated with at least one of antistatic agent TM, octadecyl diethanolamine, PEG, methyl acrylate, polyethylene oxide and polyether ester amide. The dampproof covering layer 43 is one of a triamine polyester surface layer, a PVC wood grain veneer layer and a water transfer printing surface layer. The glue is PUR hot melt adhesive. The connecting spray coating 45 is RTV paint with waterproof and dampproof natures. The molding pulp is a pulp used for manufacturing pulp molded products, for example, the pulp with several additives mentioned in the paper “Research on strength properties of pulp molded products based on pulp additives” with the issue number of CNKI: SUN: SYHH.0.2020-01-033.

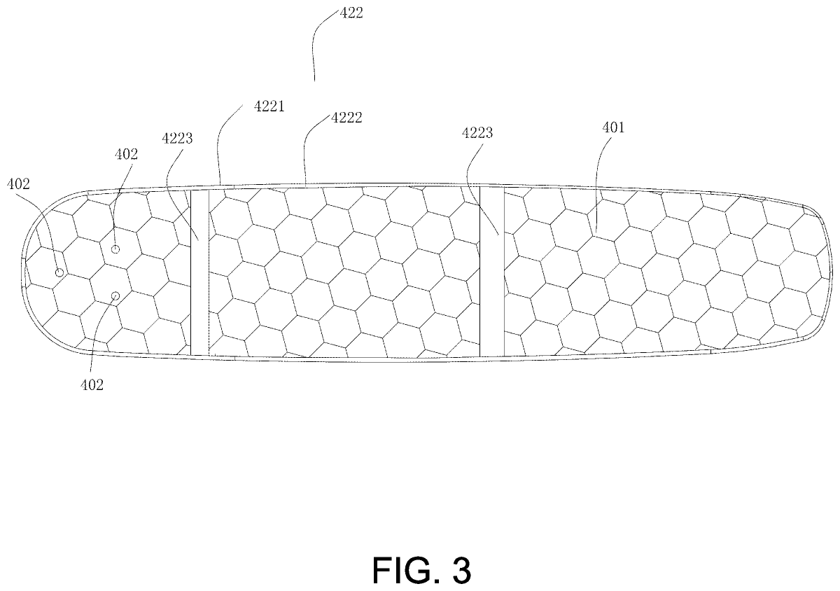

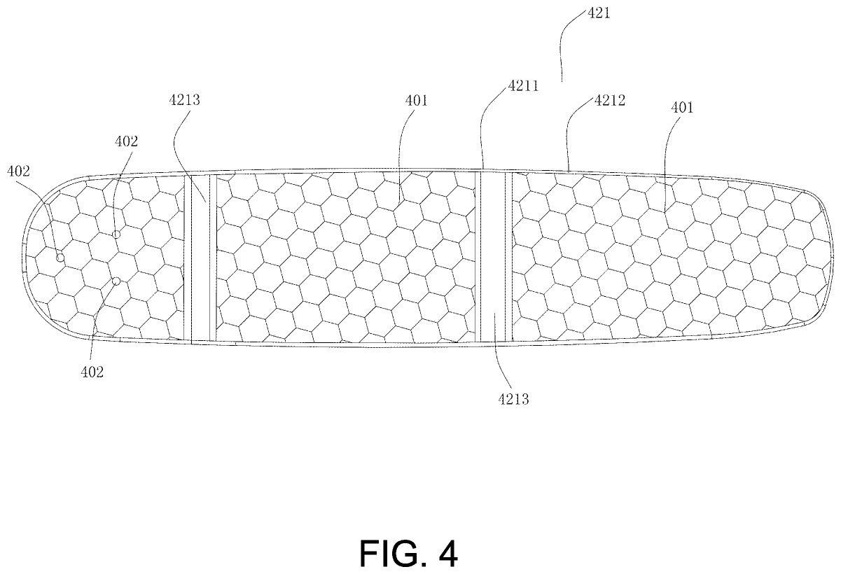

As shown in FIG. 3 to FIG. 4, the lower shell 422 includes a lower connection plate 4221, the lower connection plate 4221 is provided with a connecting protrusion 4222 and the lower connection plate 4221 is further provided with a plurality of protruded ribs 4223, the upper shell 421 includes an upper connection plate 4211, the upper connection plate 4211 is provided with a protrusion part 4212 and the protrusion part 4212 defines a fixing clamping groove 4213 capable of being fixed onto the rib 4223 in a clamping manner, the connecting protrusion 4222 and the protrusion part 4212 form the gap when the lower shell 422 and the upper connection plate 4211 are in clamping connection. The rib 4223 and the fixing clamping groove 4213 not only are used for distinguishing the lower shell 422 from the upper shell 421, but also are matched and fixed to each other to enhance the overall support strength and stress strength of the blade main body layer 42.

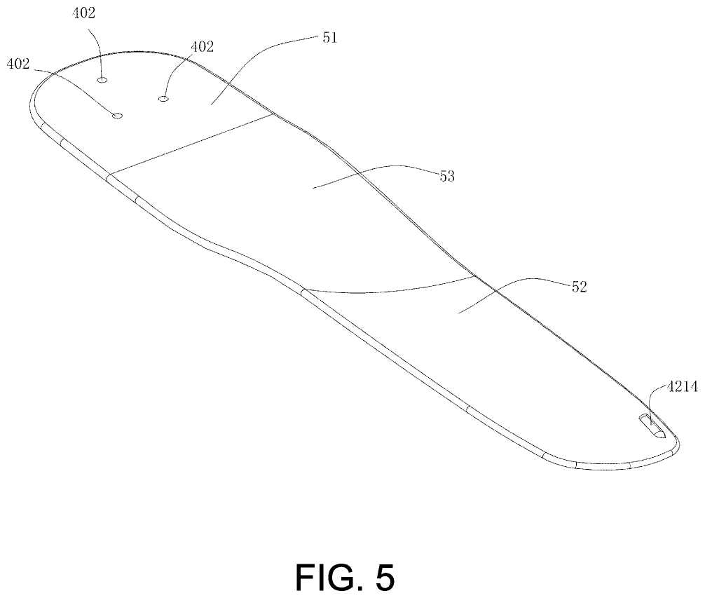

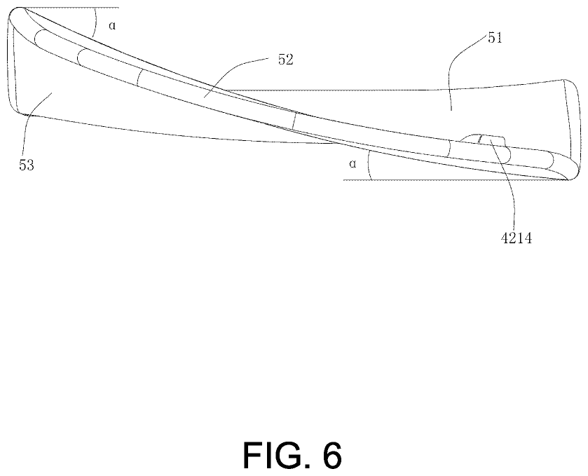

As shown in FIG. 5 to FIG. 6, the upper shell 421 and the lower shell 422 both include a tabulate fixing part 51, a tail edge of the fixing part 51 is connected with a blade part 52, and between the fixing part 51 and the blade part 52 is arranged a transition part 53 allowing an oblique arrangement of the blade part 52 relative to the horizontal plane. The wind blown by the blade part 52 towards the underneath of the ceiling fan is in some angle, thus simulating the natural wind. Thus, the wind blown by the ceiling fan is softer and of wider range.

As shown in FIG. 5 to FIG. 6, the transition part 53 is twisted from head to tail, such that one side of the blade part 52 is protruded upwards and the other side is protruded downwards, which makes the blade part 52 inclined towards a rotating direction. The transition part 53 causes an inclined angle α in a range of 15-30 degrees between the blade part 52 and the horizontal plane. The blade main body layer 42 is a large-area aerofoil type blade, and when the inclined angle α between the blade part 52 and the horizontal plane is set to be between 15 and 30 degrees, the air flow can be cut to be more delicate and soft and can be cut evenly and intensively, which better restores the softness and tenderness of the natural wind, and better suits the comfortable wind receiving point of the human body. Moreover, the ultra-far air supply distance of the blade main body layer 42 makes the cooling air from an air conditioner uniformly distributed in a room.

As shown in FIG. 5, an upper surface of the upper shell 421 near a tail part is provided with a protrusion 4214, one side of the protrusion 4214 presents a cambered surface, and one side of the protrusion 4214 presents a vertical surface. The protrusion 4214 has the cambered surface protruded upwards, which cuts the air flow more smoothly, and then reduces the hindrance suffered by the tail part and reduces the noise the ceiling fan blade 4 causes when cutting the air flow.

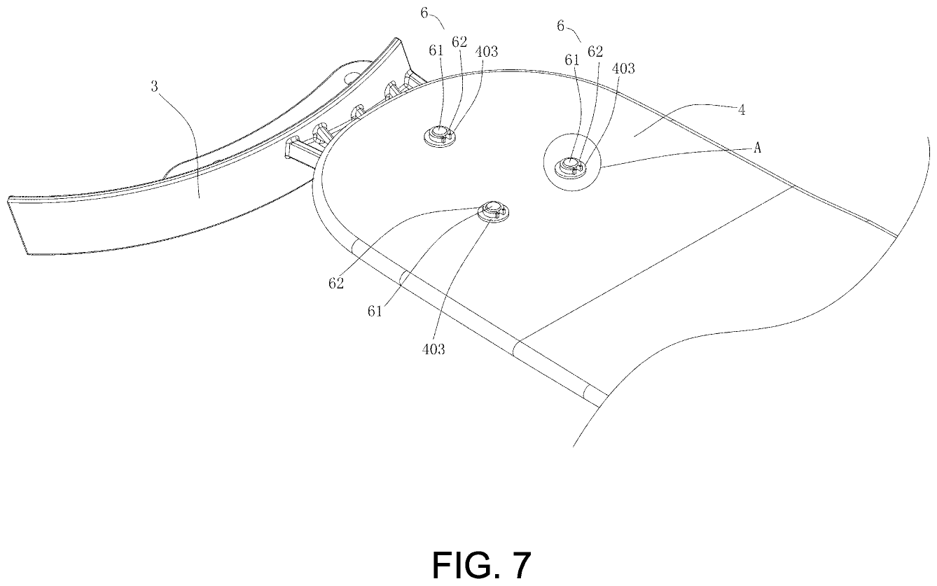

As shown in FIG. 7, the connecting piece 3 is a connecting sheet, one end of the connecting sheet is fixed to the electric machine 2, and between the other end of the connecting sheet and the ceiling fan blade 4 is arranged a quick installation structure 6 capable of connecting them. The quick installation structure 6 is provided for a user to perform quick installation.

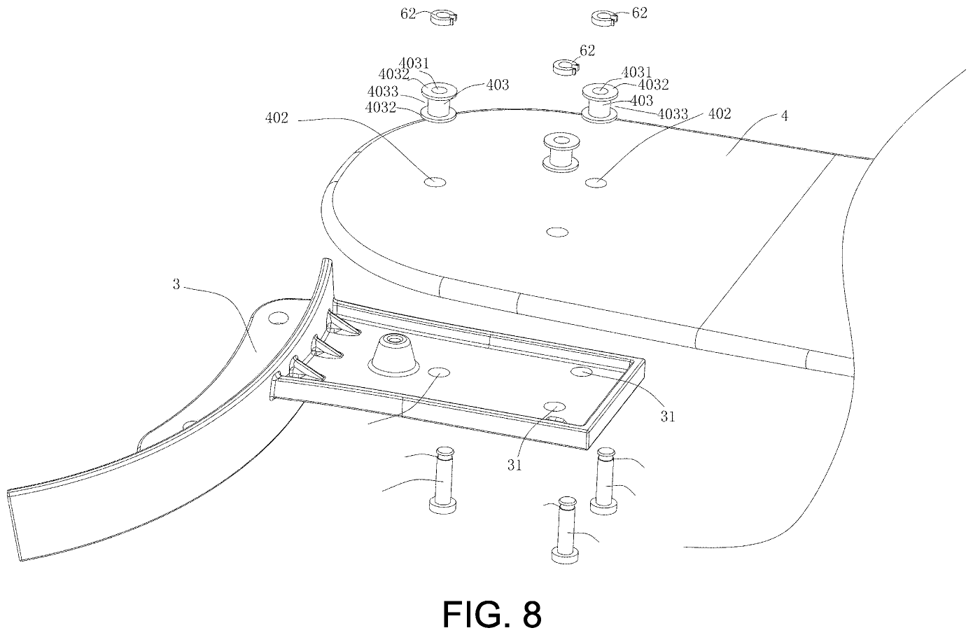

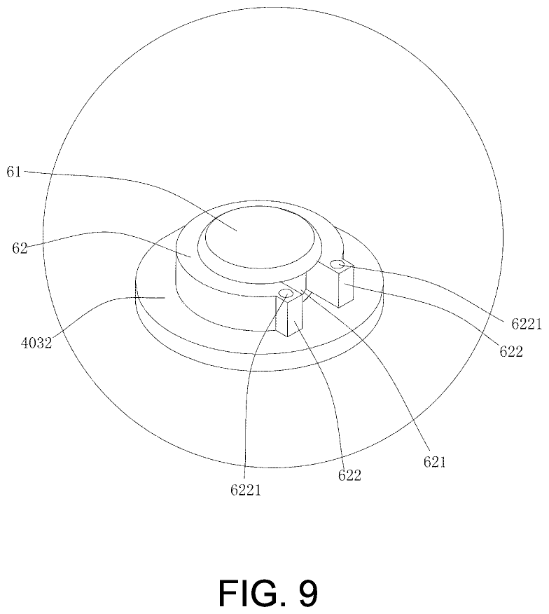

As shown in FIG. 8 and FIG. 9, the connecting piece 3 defines a plurality of connecting holes 31, the ceiling fan blade 4 defines mounting holes 402 corresponding to the positions of the plurality of connecting holes 31, the quick installation structure 6 includes a connecting pin 61 which can penetrate through the connecting piece 3 and the ceiling fan blade 4 at the same time, and the connecting pin 61 is connected with a clamping lock element 62 which, when clamped on the connecting pin 61, can press against the connecting pin 61 and the surface of the ceiling fan blade 4 at the same time so as to fasten the ceiling fan blade 4 and the connecting piece 3.

As shown in FIG. 8 to FIG. 10, a rubber ring 403 is installed inside the mounting hole 402, the rubber ring 403 defines in the middle a channel 4031 allowing the connecting pin 61 to pass through, both ends of the rubber ring 403 are provided with a protruded ring 4032, between the two protruded rings 4032 is defined a meshing clamping groove 4033 which can fit the upper and lower surfaces of the ceiling fan blade 4 and can be meshed with the ceiling fan blade 4, the clamping lock element 62 is a circular clamping lock sheet, the clamping lock sheet defines an opening clamping groove 621 allowing the connecting pin 61 to be clamped in, the clamping lock sheet at two ends of the opening clamping groove 621 is provided with an extension part 622 extending outwards, the extension part 622 defines a through hole 6221 allowing a quick installation tool to be inserted into, the opening of the opening clamping groove 621 can be expanded for the connecting pin 61 to be clamped in when a quick installation tool is inserted into the through hole 6221 and a force is applied, a head part of the connecting pin 61 presents an umbrella shape, the connecting pin 61 further defines a clamping lock groove 611 allowing the clamping lock element 62 to be clamped in, a diameter of the connecting pin 61 at the clamping lock groove 611 is less than other portions, and when the clamping lock sheet is clamped in the clamping lock groove 611, upper and lower ends of the clamping lock sheet press against the rubber ring 403 and the inner wall of the connecting pin 61 respectively to as to fasten the connecting piece 3 and the ceiling fan blade 4. The connecting piece 3 is a fan blade pin. When connect the fan blade pin to the ceiling fan blade 4, first install the rubber ring 403 in the mounting hole 402 of the ceiling fan blade 4, such that the rubber ring 403 can be meshed with the side wall of the mounting hole 402, then align the ceiling fan blade 4 to the connecting hole 31 on the connecting piece 3, now the channel 4031 on the rubber ring 403 is aligned to the connecting hole 31, next make the connecting pin 61 pass through the connecting hole 31 and the channel 4031 in turn and make the clamping lock groove 611 exposed to one side of the ceiling fan blade 4, and insert a circlip plier into the through hole 6221 on the extension part 622 and press the circlip plier, now the circlip plier expands the groove opening of the opening clamping groove 621 of the clamping lock element 62, then clamp the clamping lock element 62 in the clamping lock groove 611 of the connecting pin 61 and finally loosen the hand. Since the clamping lock element 62 has a deformation capability, the clamping lock element 62 can be meshed on the connecting pin 61 through the circumferential surface of the opening clamping groove 621 when reset, now the upper and lower ends of the clamping lock element 62 press against the rubber ring 403 and the inner wall of the connecting pin 61 respectively to as to fasten the connecting piece 3 and the ceiling fan blade 4.

In another aspect, the present disclosure further provides a method for manufacturing a ceiling fan blade, including the following steps of:

a. cutting a carbon fiber sheet along an outline of the ceiling fan blade to obtain an inner core layer 41;

b. importing a molding pulp into molds corresponding to an upper shell 421 and a lower shell 422 respectively to prepare an upper shell 421 and a lower shell 422;

c. hole-processing and groove-processing the inner core layer 41 and then brushing a glue over it and finally mounting it to the lower shell 422;

d. brushing a glue over corresponding fitting surfaces of the lower shell 422 and the upper shell 421 and then putting the upper shell 421 onto the lower shell 422;

e. sticking a dampproof covering layer 43 on outer surfaces of the upper shell 421 and the lower shell 422;

f. sticking an antistatic covering layer 44 on the outer surface of the upper shell 421;

g. spraying a connecting spray coating 45 along lateral surfaces of the upper shell 421 and the lower shell 422.

What is claimed is:

1. A ceiling fan, comprising a shell (1), wherein an electric machine (2) is installed in the shell (1), the electric machine (2) is connected with at least three connecting pieces (3), and each of the connecting pieces (3) is detachably connected with a ceiling fan blade (4), the ceiling fan blade (4) comprises an inner core layer (41) made of a carbon-fiber material, an outside of the inner core layer (41) is connected with a blade main body layer (42) made of a molding pulp material, both upper and lower ends of the blade main body layer (42) are provided with a dampproof covering layer (43), and an antistatic covering layer (44) is further arranged on an upper side of the blade main body layer (42), the blade main body layer (42) is an aerofoil type blade, and the blade main body layer (42) comprises an upper shell (421) and a lower shell (422) in clamping connection with the upper shell (421), the upper shell (421) and the lower shell (422) are both hollow structures and a honeycomb structure (401) is arranged on the hollow portion of both the upper shell (421) and the lower shell (422), a gap is formed between connecting surfaces of the upper shell (421) and the lower shell (422), a sealing coating (423) is arranged in the gap, and a connecting spray coating (45) is sprayed on peripheral edges of the upper shell (421) and the lower shell (422).

2. The ceiling fan according to claim 1, wherein the lower shell (422) comprises a lower connection plate (4221), the lower connection plate (4221) is provided with a connecting protrusion (4222) and the lower connection plate (4221) is further provided with a plurality of protruded ribs (4223), the upper shell (421) comprises an upper connection plate (4211), the upper connection plate (4211) is provided with a protrusion part (4212) and the protrusion part (4212) defines a fixing clamping groove (4213) capable of being fixed onto the rib (4223) in a clamping manner, the connecting protrusion (4222) and the protrusion part (4212) form the gap when the lower shell (422) and the upper connection plate (4211) are in clamping connection.

3. The ceiling fan according to claim 1, wherein the upper shell (421) and the lower shell (422) both comprise a tabulate fixing part (51), a tail edge of the fixing part (51) is connected with a blade part (52), and between the fixing part (51) and the blade part (52) is arranged a transition part (53) allowing an oblique arrangement of the blade part (52) relative to the horizontal plane.

4. The ceiling fan according to claim 3, wherein the transition part (53) is twisted from head to tail, such that one side of the blade part (52) is protruded upwards and the other side is protruded downwards, which makes the blade part (52) inclined towards a rotating direction.

5. The ceiling fan according to claim 4, wherein the transition part (53) causes an inclined angle (α) in a range of 15-30 degrees between the blade part (52) and the horizontal plane.

6. The ceiling fan according to claim 1, wherein an upper surface of the upper shell (421) near a tail part is provided with a protrusion (4214), one side of the protrusion (4214) presents a cambered surface, and one side of the protrusion (4214) presents a vertical surface.

7. The ceiling fan according to claim 1, wherein the connecting piece (3) is a connecting sheet, one end of the connecting sheet is fixed to the electric machine (2), and between the other end of the connecting sheet and the ceiling fan blade (4) is arranged a quick installation structure (6) capable of connecting them.

8. The ceiling fan according to claim 7, wherein the connecting piece (3) defines a plurality of connecting holes (31), the ceiling fan blade (4) defines mounting holes (402) corresponding to the positions of the plurality of connecting holes (31), the quick installation structure (6) comprises a connecting pin (61) which can penetrate through the connecting piece (3) and the ceiling fan blade (4) at the same time, and the connecting pin (61) is connected with a clamping lock element (62) which, when clamped on the connecting pin (61), can press against the connecting pin (61) and the surface of the ceiling fan blade (4) at the same time so as to fasten the ceiling fan blade (4) and the connecting piece (3).

9. The ceiling fan according to claim 8, wherein a rubber ring (403) is installed inside the mounting hole (402), the rubber ring (403) defines in the middle a channel (4031) allowing the connecting pin (61) to pass through, both ends of the rubber ring (403) are provided with a protruded ring (4032), between the two protruded rings (4032) is defined a meshing clamping groove (4033) which can fit the upper and lower surfaces of the ceiling fan blade (4) and can be meshed with the ceiling fan blade (4), the clamping lock element (62) is a circular clamping lock sheet, the clamping lock sheet defines an opening clamping groove (621) allowing the connecting pin (61) to be clamped in, the clamping lock sheet at two ends of the opening clamping groove (621) is provided with an extension part (622) extending outwards, the extension part (622) defines a through hole (6221) allowing a quick installation tool to be inserted into, the opening of the opening clamping groove (621) can be expanded for the connecting pin (61) to be clamped in when a quick installation tool is inserted into the through hole (6221) and a force is applied, a head part of the connecting pin (61) presents an umbrella shape, the connecting pin (61) further defines a clamping lock groove (611) allowing the clamping lock element (62) to be clamped in, a diameter of the connecting pin (61) at the clamping lock groove (611) is less than other portions, and when the clamping lock sheet is clamped in the clamping lock groove (611), upper and lower ends of the clamping lock sheet press against the rubber ring (403) and the inner wall of the connecting pin (61) respectively to as to fasten the connecting piece (3) and the ceiling fan blade (4).

10. A method for manufacturing a ceiling fan blade, comprising the following steps of:
a. cutting a carbon fiber sheet along an outline of the ceiling fan blade to obtain an inner core layer (41);
b. importing a molding pulp into molds corresponding to an upper shell (421) and a lower shell (422) respectively to prepare an upper shell (421) and a lower shell (422);
c. hole-processing and groove-processing the inner core layer (41) and then brushing a glue over it and finally mounting it to the lower shell (422);
d. brushing a glue over corresponding fitting surfaces of the lower shell (422) and the upper shell (421) and then putting the upper shell (421) onto the lower shell (422);
e. sticking a dampproof covering layer (43) on outer surfaces of the upper shell (421) and the lower shell (422);
f. sticking an antistatic covering layer (44) on the outer surface of the upper shell (421);
g. spraying a connecting spray coating (45) along lateral surfaces of the upper shell (421) and the lower shell (422).
